(19) United States
(12) Patent Application Publication
(10) Pub. No.: US 2015/0360604 A1
(43) Pub. Date: Dec. 17, 2015

(54) ELECTROLUMINESCENT LICENSE PLATE ASSEMBLY FOR VEHICLES

(71) Applicant: FORD GLOBAL TECHNOLOGIES, LLC, Dearborn, MI (US)

(72) Inventors: Graeme Cameron, Ivanhoe (AU); Howard Schulz, Camberwell (AU)

(21) Appl. No.: 14/307,020

(22) Filed: Jun. 17, 2014

(51) Int. Cl. B60Q 1/56; G09F 13/22; B60R 13/10

(52) U.S. Cl. CPC B60Q 1/56; B60R 13/105; G09F 13/22

(57) ABSTRACT

An exterior vehicle component assembly includes an exterior vehicle component having a license plate cavity and an electroluminescent license plate assembly received and held in that cavity. The electroluminescent license plate assembly includes an electroluminescent panel and a transparent cover panel overlying the electroluminescent panel. The transparent cover fits flush with the exposed face of the exterior vehicle component.

### TECHNICAL FIELD

This document relates generally to the field of vehicle illumination and, more particularly, to an electroluminescent license plate assembly incorporated into an exterior vehicle component assembly such as a bumper or body panel.

### BACKGROUND

License plate technology has not changed much over the development of the motor vehicle. License plates are still made from rectangular metal plates that are stamped and painted to provide license plate indicia. Vehicles must be designed with relatively large flat rectangular areas at the front and rear of the vehicle to receive the license plate. Further, the vehicle must also incorporate illumination for lighting the license plate. Accordingly, the rectangular area is typically formed as a recess in the exterior of the body.

The provision of a surface for lighting a license plate adversely affects the styling and aerodynamics of a vehicle. Further, even when the license plate mounting point is recessed, it is often difficult to illuminate the license plate evenly using conventional lighting technology.

This document relates to an electroluminescent license plate assembly and an exterior vehicle component assembly incorporating that electroluminescent license plate assembly that allows for the incorporation of a license plate on a vehicle without comprising aesthetics, styling or aerodynamics while at the same time providing for improved illumination of the license plate.

### SUMMARY

In accordance with the purposes and benefits described herein, a bumper assembly is provided comprising a bumper including a license plate cavity and an electroluminescent license plate assembly received and held in that cavity. The electroluminescent license plate assembly includes an electroluminescent panel and a transparent cover panel overlying the electroluminescent panel. Fasteners secure those two panels together. In one embodiment those fasteners comprise resilient mounting tabs on the cover panel that engage cooperating lugs or flanges on the electroluminescent panel. In one embodiment the bumper includes an exposed face and the transparent cover panel fits flush with the exposed face.

The electroluminescent license plate assembly further includes a mask that is received and held between the electroluminescent panel and the cover panel. The mask forms license plate indicia backlit by the electroluminescent panel which provides even, consistent lighting of the desired intensity across the entire license plate.

In one possible embodiment the electroluminescent panel includes a face covered with electroluminescent paint. In one possible embodiment the electroluminescent panel is made from a plastic material. In one possible embodiment the electroluminescent panel is connected to a wiring harness behind the bumper.

In accordance with an additional aspect, an exterior vehicle component assembly is provided comprising an exterior vehicle component including a license plate cavity and an electroluminescent license plate assembly received and held in that cavity. The vehicle component is selected from a group of components consisting of a front bumper, a rear bumper and a body panel.

In the following description, there are shown and described several preferred embodiments of the vehicle component assembly. As it should be realized, the vehicle component assembly is capable of other, different embodiments and its several details are capable of modification in various, obvious aspects all without departing from the assembly as set forth and described in the following claims. Accordingly, the drawings and descriptions should be regarded as illustrative in nature and not as restrictive.

### BRIEF DESCRIPTION OF THE DRAWINGS

The accompanying drawings incorporated herein and forming a part of the specification, illustrate several aspects of the exterior vehicle component assembly and together with the description serve to explain certain principles thereof. In the drawings:

FIG. 1 is a perspective view of a vehicle illustrating a bumper assembly incorporating an electroluminescent license plate assembly.

FIG. 2 is a partially exploded perspective view of the license plate assembly that is held in a cavity in the vehicle component.

FIG. 3 is a schematic top plan view illustrating the structural details of the bumper assembly including the bumper, license plate cavity and electroluminescent license plate assembly received and held in that cavity.

Reference will now be made in detail to the present preferred embodiment of the exterior vehicle component assembly, examples of which are illustrated in the accompanying drawings.

### DETAILED DESCRIPTION

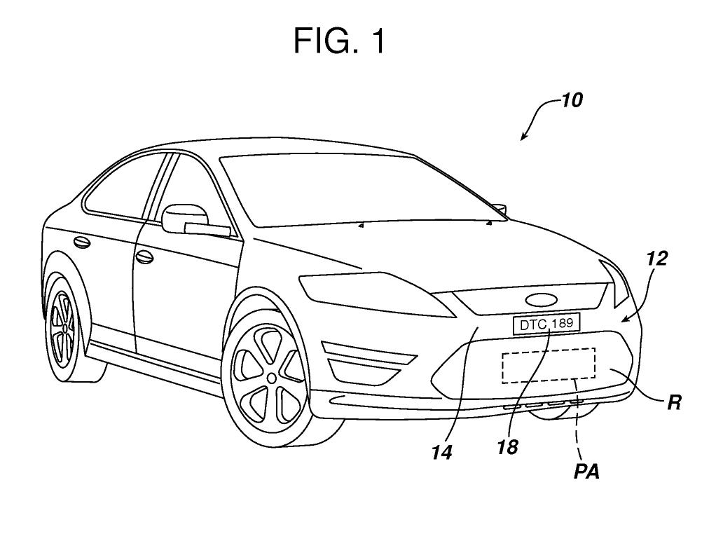

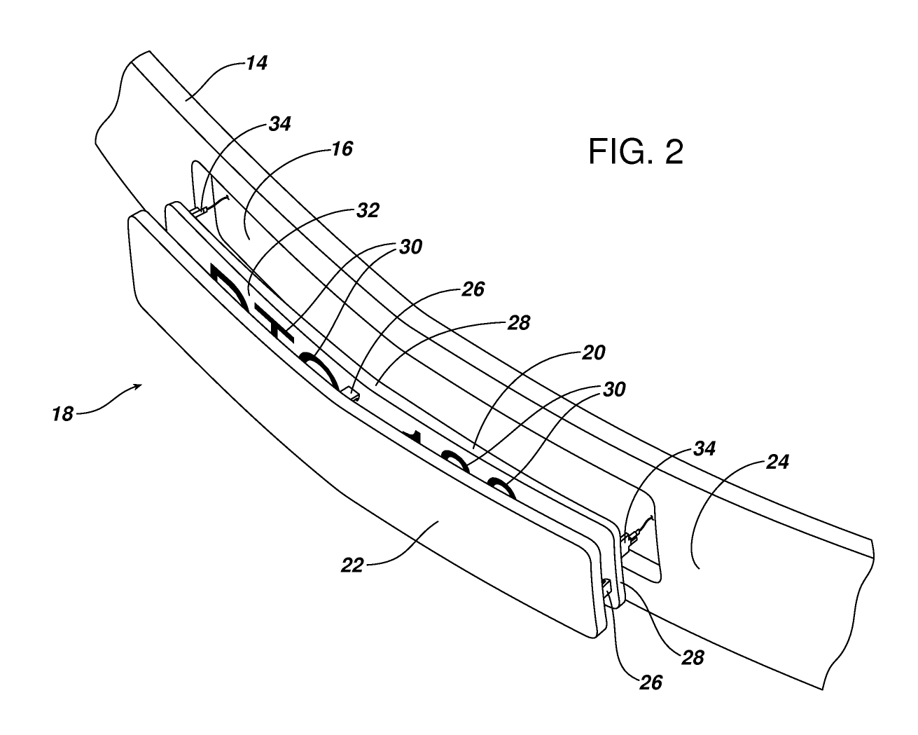

Reference is now made to FIG. 1 illustrating a vehicle 10 including an exterior vehicle component assembly in the form of a front bumper assembly 12. The bumper assembly 12 incorporates a bumper 14 including a license plate cavity or opening 16. See also FIG. 2. An electroluminescent license plate assembly 18 is received and held in the cavity 16. Thus, as illustrated in FIG. 1, the license plate assembly 18 may be positioned in the bumper 14 above the radiator air intake opening R of the vehicle 10. In contrast, a prior art license plate PA is typically positioned where it partially obstructs the radiator air intake opening R and restricts cooling.

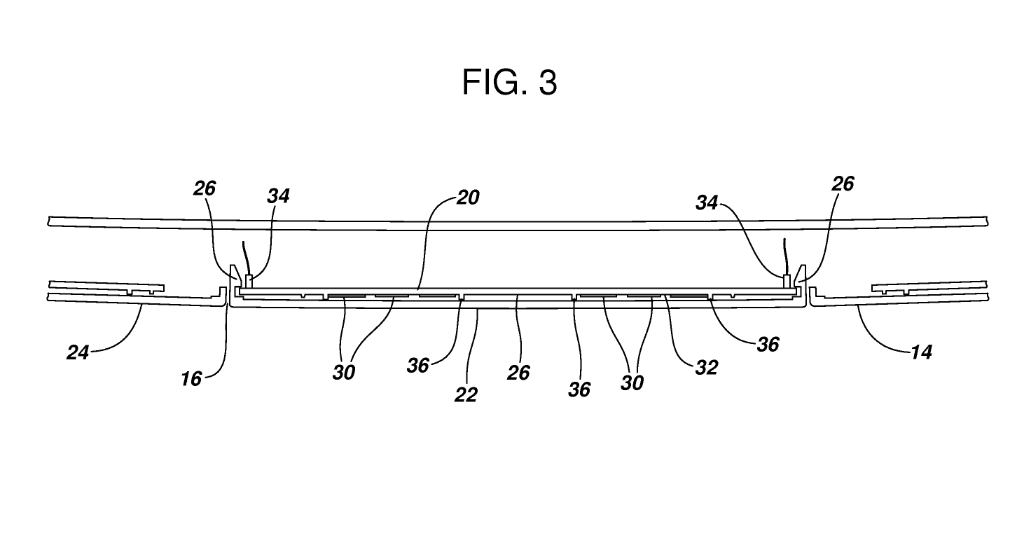

As best illustrated in FIGS. 2 and 3, the electroluminescent license plate assembly 18 includes an electroluminescent panel 20 and a transparent cover panel 22 that overlies the electroluminescent panel. As illustrated in FIGS. 1 and 3 the bumper 14 includes an exposed face 24. The transparent cover panel 22 fits flush with the exposed face 24 of the bumper 14. As a result, the license plate area of the vehicle 10 may be provided with more aesthetically pleasing styling and enhanced aerodynamics.

A mask 30 is received and held between the electroluminescent panel 20 and the transparent cover panel 22. In the illustrated embodiment, the mask 30 comprises individual indicia of letters and/or numbers that form the license plate registration. In another embodiment the mask 30 may comprise a single sheet of vinyl or other appropriate material in which the indicia have been cut from the sheet. The mask 30 may be opaque so as to prevent the passage of light or transparent but of a contrasting color so as to be clearly visible when backlit by the electroluminescent panel 20. In one embodiment, the mask 30 is backlit by the electroluminescent panel 20 which provides clear and consistent lighting over the entire surface of the license plate assembly 18 at the desired intensity so that the indicia is clearly visible.

One positions the mask 30, which may be backed with an appropriate adhesive, in proper position on the electroluminescent panel 20 and then attaches the electroluminescent panel to the cover panel 22. More specifically, as illustrated in FIGS. 2 and 3, fasteners 26 secure the electrochemical panel 20 to the cover panel 22. In the illustrated embodiment the fasteners 26 comprise resilient mounting clips provided at spaced locations around the cover panel 22. The electroluminescent panel 20 includes cooperating lugs or mounting flanges 28 that are engaged by the mounting clips 26 to provide a snap fit. Obviously, other fastening devices may be utilized including, but not limited to, screws or the like. The entire license plate assembly 18 may then be mounted in the bumper 14 by appropriate fasteners such as screws from the rear side, resilient clips from the front side or both (not shown).

In one possible embodiment the electroluminescent panel 20 is made from a plastic material including, for example, fiber reinforced composite materials. The electroluminescent panel 20 includes a face 32 covered in electroluminescent paint. Such a paint is commercially available under the trademark LUMILOR™ as marketed by Darkside Scientific LLC. Such a paint may be applied in less than 3 mils total thickness and will conform to any surface and any shape. The paint may be sprayed on or dip coated. The electroluminescent paint is durable and bright and provides illumination without the possibility of delamination. Further details respecting this paint may be found in U.S. Pat. No. 8,470,388 and published U.S. Patent Application Publication No. 2013/0171903, the full disclosures of which are incorporated herein by reference. As illustrated, the electroluminescent panel 20 and more particularly, the electroluminescent paint on the face 32 of the panel 20 (in this embodiment) is powered by the vehicle electrical system via connection through the wiring harness and wiring loom 34 that is routed and extends behind the bumper 14.

In another possible embodiment, the electroluminescent panel 20 is constructed from a light emitting plastic known as field-induced polymer electroluminescent technology (FIPEL). Such technology is disclosed in U.S. Pat. No. 8,476,820, the full disclosure of which is incorporated herein by reference.

In still another embodiment, EL film technology is used to create the mask or registration numbers 30 which are cut and applied with adhesive to the backing panel 20. Such a film is available from DuPont under the trademark LuxPrint®.

In yet another possible embodiment the electroluminescent panel 20 is constructed from a semi-conductive conjugated polymer of a type described in, for example, U.S. Pat. No. 5,247,190, the full disclosure of which is incorporated herein by reference.

It should be appreciated that while a front bumper assembly 12 is illustrated, the exterior vehicle component assembly incorporating the electroluminescent license plate assembly 18 may also comprise a rear bumper assembly or even a body panel of the vehicle. Such a body panel may include but is not necessarily limited to a rear body panel or trunk lid of an automobile, a tailgate of a truck or SUV or even a body panel of a prime mover or locomotive as well as body panels of other vehicles. Further, while the electroluminescent license plate assembly 18 of the illustrated embodiment includes a removable transparent cover panel 22, it should be appreciated that cover panel 22 may be permanently or semi-permanently affixed flush with the exposed face of the vehicle component so long as the electroluminescent panel 20 and mask 30 displayed thereon may be accessed from the rear such as through a trunk of the vehicle.

In the illustrated embodiment, spacers or bumpers 36 are provided on the electroluminescent panel 20 to maintain an offset between the electroluminescent panel and the transparent cover panel 22 so that the cover panel will not rub the mask/indicia 30. These spacers 36 may also be covered with the electroluminescent paint so that the background lighting is continuous across the entire license plate. Of course, in an alternative embodiment the spacers 36 may be provided on the transparent cover panel 22. Optionally, the spacers 36 may be eliminated.

It should be appreciated that the license plate assembly 18 may be provided to the car dealer in a dealer fit bag shipped within the interior of the vehicle. The dealer would attach the adhesive mask 30, representing the registration number, to the electroluminescent panel 20, secure the panel 20 to the cover 22, connect the wiring harness 34 and then secure the entire assembly 18 to the bumper 14.

The foregoing has been presented for purposes of illustration and description. It is not intended to be exhaustive or to limit the embodiments to the precise form disclosed. Obvious modifications and variations are possible in light of the above teachings. For example, a full or partial seal such as an O-ring seal may be provided between the outer perimeter of the electroluminescent panel 20 and the cover panel 22 or the outer perimeter of the cover panel and the bumper 14. All such modifications and variations are within the scope of the appended claims when interpreted in accordance with the breadth to which they are fairly, legally and equitably entitled.

1. A bumper assembly, comprising:
a bumper including a license plate cavity; and
an electroluminescent license plate assembly received and held in said cavity, wherein said electroluminescent license plate assembly includes an electroluminescent panel having a face covered with electroluminescent paint.

2. (canceled)

3. The assembly of claim 1, wherein said electroluminescent license plate assembly includes a transparent cover panel overlying said electroluminescent panel.

4. The assembly of claim 3, wherein said bumper includes an exposed face and said transparent cover panel fits flush with said exposed face.

5. The assembly of claim 4, further including fasteners securing said electroluminescent panel to said cover panel.

6. The assembly of claim 5, wherein said fasteners are resilient mounting tabs provided at opposed ends of said cover panel.

7. The assembly of claim 6, wherein said electroluminescent panel includes cooperating lugs that are engaged by said mounting tabs.

8. The assembly of claim 5, further including a mask received and held between said electroluminescent panel and said cover panel.

9. The assembly of claim 8, wherein said mask forms license plate indicia backlit by said electroluminescent panel.

10. (canceled)

11. The assembly of claim 1, wherein said electroluminescent panel is connected to a wiring harness extending behind said bumper.

12. (canceled)

13. The assembly of claim 1, wherein said electroluminescent license plate assembly includes a backing panel and an electroluminescent mask received and held on said backing panel.

14. An exterior vehicle component assembly, comprising:
an exterior vehicle component including a license plate cavity; and
an electroluminescent license plate assembly received and held in said cavity, wherein said electroluminescent license plate assembly includes an electroluminescent panel having a face covered in electroluminescent paint.

15.-16. (canceled)

17. The assembly of claim 14, wherein said electroluminescent license plate assembly includes a transparent cover panel overlying said electroluminescent panel.

18. The assembly of claim 17, wherein said vehicle component includes an exposed face and said transparent cover panels fits flush with said exposed face.

19. The assembly of claim 18, wherein said vehicle component is selected from a group of components consisting of a front bumper, a rear bumper and a body panel.

20. The assembly of claim 14, wherein said electroluminescent license plate assembly includes a backing panel and an electroluminescent mask received and held on said backing panel.

21. A bumper assembly for a motor vehicle having a radiator intake opening, comprising:
a bumper including a license plate cavity positioned above the radiator intake opening such that cooling is not restricted; and
an electroluminescent license plate assembly received and held in said cavity.
